(19) United States
(12) Patent Application Publication
(10) Pub. No.: US 2006/0172193 A1
(43) Pub. Date: Aug. 3, 2006

(54) Alkaline battery

(75) Inventors: Shinichi Iwamoto, Osaka (JP); Yoshihisa Hirose, Osaka (JP); Noriyuki Ito, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/345,331

(22) Filed: Feb. 2, 2006

(30) Foreign Application Priority Data
Feb. 3, 2005 (JP) P2005-027499
Dec. 19, 2005 (JP) P2005-364263

(51) Int. Cl. H01M 2/08; H01M 4/42

(52) U.S. Cl. 429/185; 429/229

(57) ABSTRACT

An alkaline battery comprising a positive electrode, a negative electrode containing zinc or zinc alloy particles, an outer body, and a resin sealing member having a thin-walled part for preventing explosion, wherein all zinc or zinc alloy particles in the negative electrode pass through sieve openings of 80 mesh and 20 to 80% by weight of the zinc or zinc alloy particles pass through sieve openings of 200 mesh sieve, which has excellent load characteristics and high safety achieved by the prevention of heat-generation at the time of short-circuiting.

### BACKGROUND OF THE INVENTION

1. Field of the Invention

The present invention relates to an alkaline battery, in particular, an alkaline battery having excellent load characteristics and high safety achieved by the prevention of heat-generation at the time of short-circuiting.

2. Description of the Related Art

Alkaline batteries which utilize zinc as a negative electrode active material are used as power sources for various electronic equipments, and have required characteristics which vary depending on their usage. Particularly, in the case of digital cameras the use of which has spread rapidly in recent years, in order to increase the capacity to shoot as many pictures as possible, the batteries are required to provide a higher capacity and further improved load characteristics such as a large current discharge characteristic. Therefore, battery designs fulfilling these demands are sought.

To improve the load characteristics, various attempts have been made, for example, the improvement of positive electrodes, the improvement of zinc contained in negative electrodes.

For example, JP-A-10-228899 proposes the improvement of load characteristics of a battery by controlling a density of manganese dioxide particles serving as a positive electrode active material in a specific range.

JP-A-2001-512284 discloses the improvement of load characteristics of a battery comprising zinc or zinc alloy particles serving as a negative electrode material by decreasing the particle size of those particles in comparison with conventional zinc or zinc alloy particles.

However, as the particle size of the zinc or zinc alloy particles decreases, the reactive surface of the particles increases so that heat is generated by a rapid discharge reaction at the time of short-circuiting although the load characteristics of the battery is improved.

In the case of an alkaline battery having a negative electrode comprising zinc or zinc alloy particles as an active material, if short-circuit is formed, zinc oxide, which is formed by discharging, is reduced and forms zinc, and zinc formed is corroded to rapidly generate gas, which results in the expansion or burst of the battery. For example, a cylindrical alkaline battery has a structure as shown in FIG. 3, in which a power generating unit comprising a positive electrode 2, a separator 3 and a negative electrode 3 is loaded in an outer can 1, a negative electrode-terminal plate 7 is placed at an open end 1a of the outer can 1, and a sealing member 6 is used for sealing the open end 1a. The sealing member 6 is usually made of a resin and has a thin-walled part 63. In the case of the alkaline battery having the structure of FIG. 3, when the rapid generation of gas is caused by short-circuiting, an explosion protection system functions, for example, the think-walled part 63 of the resin sealing member 6 preferentially bursts, and thus the gas generated is discharged outside the battery through a gas-venting hole 91 of a metal washer 9 and a gas-venting hole 71 of the negative electrode-terminal plate 7 so that the interior pressure of the battery decreases. Thus, the expansion or bursting of the outer can 1 is prevented.

However, when the particle size of the zinc or zinc alloy particles used in the negative electrode decreases, the amount of heat generated at the time of short-circuiting increases so that the resin sealing member 6 is softened and deformed as shown in FIG. 3. As a result, the sealing member 6 does not burst at the thin-walled part 63 at a specified pressure and thus the inner pressure of the battery is not reduced and the burst of the battery cannot be adequately prevented.

### SUMMARY OF THE INVENTION

The object of the present invention is to provide an alkaline battery which comprises a negative electrode containing zinc or zinc alloy particles, and which has excellent load characteristics and high safety.

Accordingly, the present invention provides an alkaline battery comprising a positive electrode, a negative electrode containing zinc or zinc alloy particles, an outer body, and a resin sealing member having a thin-walled part for preventing explosion, wherein all zinc or zinc alloy particles in the negative electrode pass through sieve openings of 80 mesh and 20 to 80% by weight of the zinc or zinc alloy particles pass through sieve openings of 200 mesh sieve.

With the alkaline battery of the present invention, the reactivity of the negative electrode during charging and discharging is controlled by selecting the specific particle size distribution of the zinc or zinc alloy particles (hereinafter collectively referred to as “zinc base particles”), which act as a negative electrode active material. Therefore, the alkaline battery can exhibit good load characteristics while it is normally discharged. When the battery is short-circuited, the amount of heat generated is small so that the rise of the battery temperature is suppressed. Accordingly, even if gas is rapidly generated in the battery, the softening (or expansion) of the resin sealing member having the thin-walled part for preventing explosion is avoided, and thus the thin-walled part bursts before the sealing member is deformed as shown in FIG. 3, so that the increase of pressure inside the battery is prevented. In such a way, the explosion protection system of the battery normally functions and thus the explosion of the battery is prevented.

Herein, “short-circuit” is intended to mean so-called external short-circuit where the maximum electric current is at least 10 A, in which a positive electrode of a battery outer member (for example, the outer can 1 in FIG. 1 which will be explained below) and a negative electrode (for example a negative electrode-terminal plate 7 in FIG. 1) are directly connected by an external connection.

### BRIEF DESCRIPTION OF THE DRAWINGS

FIG. 1 is a cross sectional view of one example of an alkaline battery of the present invention.

FIG. 2 is a cross sectional view of another example of an alkaline battery of the present invention.

FIG. 3 is a partial cross sectional view of a conventional alkaline battery explaining the problem of the battery.

FIG. 4 is a graph showing the change of a temperature of the outer cans of the alkaline batteries produced in Example 3 and Comparative Example 2 from the start of short-circuiting.

### DETAILED DESCRIPTION OF THE INVENTION

Hereinafter, the alkaline battery of the present invention will be explained in detail.

Negative Electrode

Usually, the negative electrode comprises a gel-type mixture which contains zinc base particles as a negative electrode active material, a gelling agent and an alkaline electrolytic solution.

From the viewpoint of the prevention of gas generation due to the reaction of the negative electrode active material and the electrolytic solution, the zinc base particles is preferably zinc alloy particles comprising zinc and other metal element such as indium, bismuth or aluminum. The contents of indium, bismuth and aluminum are preferably 0.02 to 0.07% by weight, 0.007 to 0.025% by weight and 0.001 to 0.004% by weight, respectively. The zinc alloy particles may comprise only one other metal element or two or more other metal elements.

According to the present invention, all zinc base alloy particles in the negative electrode pass through sieve openings of 80 mesh and at least 20% by weight of the zinc base alloy particles pass through sieve openings of 200 mesh sieve. When the zinc base particles in the negative electrode are such fine particles, they have a large specific surface area and thus the reaction at the negative electrode can effectively proceeds, so that the battery has good load characteristics. The amount of the zinc base particles which pass through the sieve opening of 200 mesh sieve is preferably at least 30% by weight.

The amount of the zinc base particles which pass through the sieve opening of 200 mesh sieve does not exceed 80% by weight. When the amount of the fine zinc base particles contained in the negative electrode is within such a range, the reactivity of the negative electrode can be controlled within a specific range. Therefore, the amount of heat generated in the battery at the time of short-circuiting is made small and thus the rise of the battery temperature is prevented so that the softening of the resin sealing member is avoided. When the amount of the fine particles in the zinc base particles increases, the whole mass of zinc base particles becomes bulky so that the handling of the zinc base particles during the production of the battery is worsened. However, the amount of the zinc base particles which pass through the sieve openings of 200 mesh is 80% by weight or less, the increase of the bulkiness of the whole mass of the zinc base particles is suppressed and thus the handling of the zinc base particles is not worsened.

As the amount of the zinc base particles which pass through the sieve openings of 200 mesh increases, the specific surface area of the zinc base particles as a whole increases, so that the reactivity of the zinc base particles with the electrolytic solution increases. As a result, the considerable amount of the electrolytic solution is consumed by the discharging reaction and therefore the electrolytic solution tends to run short. When the electrolytic solution runs short, the utilization rate of the zinc base particles as the active material decreases and the discharge characteristics of the battery may hardly be improved. Accordingly, the amount of the zinc base particles which pass through the sieve openings of 200 mesh is preferably 70% by weight or less, more preferably 60% by weight, further preferably 50% by weight or less, not only to suppress the shortage of the electrolytic solution and to increase the discharge characteristics but also to further decrease the amount of heat generated in the battery at the time of short-circuiting in order to further improve the safety of the battery.

When the zinc base particles containing the particles passing through the sieve openings of 200 mesh in an amount within the above range is used, the amount of gas generated by the corrosion caused by the reaction of the zinc base particles with the electrolytic solution can be decreased during the storage of the alkaline battery. In addition, the negative electrode mixture has good homogeneity and flowability.

The minimum particle size of the zinc base particles in the negative electrode is preferably about 7 μm from the viewpoint of the handling property of the particles during the production of the battery.

An electrolytic solution used in the negative electrode is preferably an aqueous solution of an alkaline metal hydroxide (e.g. sodium hydroxide, potassium hydroxide, lithium hydroxide, etc.), more preferably an aqueous solution of potassium hydroxide. The concentration of the electrolytic solution is preferably 38% by weight or less in the case of the aqueous solution of potassium hydroxide. More preferably, the concentration of the aqueous solution of potassium hydroxide is 35% by weight or less, particularly preferably 33.5% by weight or less, to improve the reactivity of the negative electrode through the increase of the ionic conductivity of the electrolytic solution and thus to improve the load characteristics of the battery and to readily achieve the effect for suppressing the heat-generation at the time of short-circuiting.

When the electrolytic solution is the aqueous solution of potassium hydroxide, as the concentration of potassium hydroxide is higher, the characteristic of the battery is less deteriorated during storage. Therefore, the concentration of potassium hydroxide is at least 28% by weight, more preferably at least 30% by weight.

Examples of the gelling agent include polyacrylic acid or polyacrylates (e.g. polyacrylic acid, polysodium acrylate, polyammonium acrylate, etc.), celluloses (e.g. carboxymethylcellulose (CMC), methylcellulose, hydroxypropylcellulose, their alkaline salts, etc.), and so on. Furthermore, a combination of a crosslinked polyacrylic acid or its salt type water-absorbing polymer (e.g. polysodium acrylate, polyammonium acrylate, etc.) and other gelling agent is preferably used, as described in JP-A-2001-307746. Examples of the other gelling agent to be used in combination with the crosslinked polyacrylic acid or its salt type water-absorbing polymer include the above celluloses, crosslinked branched polyacrylic acid or its salts (e.g. sodium salt, ammonium salt, etc.) and so on. Here, the crosslinked polyacrylic acid or its salt type water-absorbing polymer preferably has an average particle size of 10 to 100 μm, and each particle thereof is preferably spherical.

The content of the zinc base particles in the negative electrode mixture is preferably 50 to 75% by weight. The content of the electrolytic solution in the negative electrode mixture is preferably 25 to 50% by weight. The content of the gelling agent in the negative electrode mixture is preferably 0.01 to 1.0% by weight.

The negative electrode mixture may optionally contain a small amount of an indium compound such as indium oxide and/or a bismuth compound such as bismuth oxide. When such an indium or bismuth compound is used, the generation of gas due to the corrosion reaction of the zinc base particles with the electrolytic solution can be effectively prevented. However, if such a compound is excessively contained in the negative electrode mixture, the load characteristics of the battery may deteriorate. Thus, the content of such a compound is determined on a case by case basis. Preferably, the amount of the indium compound or the bismuth compound is 0.003 to 0.05 part by weight per 100 parts by weight of the zinc base particles.

Positive Electrode

A positive electrode used in the battery of the present invention is usually formed by press molding a positive electrode mixture in the form of a bobbin. The positive electrode mixture is prepared by mixing an active material such as manganese oxide, nickel oxyhydroxide, etc., a conductive aid, an electrolytic solution and a binder.

The positive electrode active material preferably has a BET specific surface area of 40 to 100 m²/g. When the BET specific surface area is smaller than 40 m²/g, the reaction area is small and thus reaction efficiency is low, and the load characteristics is not improved, although the moldability is good. When the BET specific surface area exceeds 100 m²/g, the bulk density is low and thus the moldability deteriorates, although the reaction efficiency is high. To strengthen the molded body of the positive electrode and to improve the moldability of the positive electrode active material, the BET specific surface area is more preferably 60 m²/g or less. Particularly, preferably, the BET specific surface area is at least 45 m²/g.

Herein, a BET specific surface area is the total surface area of the surface of bulk active material particles and the surfaces of the micropores thereof, and is measured and calculated using the BET equation based on the theory of multi-layer molecular absorption. In measurement, a specific surface area measuring apparatus based on the nitrogen adsorption method (Macsorb HM Model 1201 manufactured by Mountech) is used.

When manganese dioxide used as a positive electrode active material, it preferably contains 0.01% to 3.0% by weight, more preferably 0.01% to 1.0% by weight of titanium. When titanium is contained in magnesium dioxide in such an amount, manganese dioxide has a larger specific surface area to increase the reaction efficiency, and thus the alkaline battery having improved load characteristics can be obtained.

As a conductive aid used in the positive electrode, carbon materials such as graphite, acetylene black, carbon black, fibrous carbon and the like are mainly used. Among them, graphite is preferably used. The amount of the conductive aid to be added is preferably at least 3 parts by weight per 100 parts by weight of the positive electrode active material. When the conductive aid is used in an amount equal to or more than the above lower limit, the conductivity of the positive electrode can be increased, and thus the reactivity of the active material is enhanced and the further increase of the load characteristics is expected. The amount of the conductive aid does not preferably exceeds 8.5 parts by weight per 100 parts by weight of the positive electrode active material, since the decrease of the amount of the active material is not desirable.

As a binder used in the positive electrode, cellulose (e.g. carboxymethylcellulose (CMC), methylcellulose, etc.), polyacrylate salt (e.g. sodium salt, ammonium salt, etc.), a fluororesin (e.g. polytetrafluoroethylene, etc.), polyolefin (e.g. polyethylene, etc.) and the like may be used. When the amount of the binder is too large, some problems such as the decrease of conductivity arise, while a small amount of the binder can improve the load characteristics of a battery since the contact of the conductive aid and the active material is enhanced. Preferably, the amount of the binder in the positive electrode mixture is from 0.1 to 1% by weight.

An electrolytic solution used in the positive electrode is preferably an aqueous solution of an alkaline metal hydroxide (e.g. sodium hydroxide, potassium hydroxide, lithium hydroxide, etc.), more preferably an aqueous solution of potassium hydroxide. The concentration of the electrolytic solution is preferably at least 45% by weight, more preferably at least 50% by weight, in the case of the aqueous solution of potassium hydroxide. When an alkaline electrolytic solution having such a concentration is used, a homogeneous positive electrode mixture can be prepared and the molded body of the positive electrode mixture has a high density so that the conductivity of the whole molded body is improved, and thus the load characteristics of the battery are enhanced. The upper limit of the concentration of the electrolytic solution is preferably 60% by weight in the case of the aqueous solution of potassium hydroxide.

Electrolytic Solution

The alkaline battery of the present invention is produced by encapsulating the positive and negative electrodes together with a separator in an outer body. The details of the production of the alkaline battery of the present invention will be explained later. As described above, each of the positive and negative electrode mixtures, which respectively constitute the positive and negative electrodes, contains respective alkaline electrolytic solutions. However, the amount of the electrolytic solutions contained in the electrodes may run short in some cases. In such a case, it is preferable to pour an additional electrolytic solution in the battery and allow it to be absorbed by the separator and/or the positive electrode.

The additional electrolytic solution to be absorbed by the separator and/or the positive electrode is preferably an aqueous solution of an alkaline metal hydroxide (e.g. sodium hydroxide, potassium hydroxide, lithium hydroxide, etc.), more preferably an aqueous solution of potassium hydroxide. The concentration of the additional electrolytic solution is preferably 33.5% by weight or less in the case of an aqueous solution of potassium hydroxide, to improve the load characteristics of the battery and to achieve the effect for suppressing the heat-generation at the time of short-circuiting. On the other hand, as the concentration of potassium hydroxide is higher, the characteristic of the battery is less deteriorated during storage at high temperature. Therefore, the concentration of potassium hydroxide is at least 28% by weight, more preferably at least 30% by weight.

To more effectively suppress the deterioration of characteristics of the battery during storage by preventing the corrosion (oxidation) of the zinc base alloy particles, at least one of the electrolytic solutions used in preparation of the positive and negative electrode mixtures and the electrolytic solution which is additionally charged preferably contains a zinc compound. The zinc compound is preferably a soluble zinc compound such as zinc oxide, zinc silicate, zinc titanate and zinc molybdate, etc. Particularly, zinc oxide is preferably used. In each electrolytic solution, the concentration of the zinc compound is preferably from 1.0 to 4.0% by weight.

In the alkaline battery of the present invention, a total water content in the battery is preferably from 0.23 to 0.275 g per gram of the positive electrode active material to achieve good operating characteristics. The water content in the battery can be adjusted by the amounts of the electrolytic solutions used.

In the alkaline battery of the present invention, any separator that is used in the conventional alkaline batteries may be used. Examples of the separator material include nonwoven fabric comprising vinylon and rayon, vinylon-rayon non-woven fabric (mixed vinylon-rayon paper), polyamide nonwoven fabric, polyolefin-rayon nonwoven fabric, vinylon paper, vinylon-linter pulp paper, vinylon-mercerized pulp paper, etc. In addition, a laminate comprising hydrophilicized microporous polyolefin film (e.g. microporous polyethylene film, microporous polypropylene film, etc.), a cellophane film and a liquid-absorbing layer such as a mixed vinylon-rayon paper may be used as a separator.

Structure and Other Elements of Alkaline Battery

In the present invention, the shape of a battery is not limited particularly, and it may be a barrel-shaped battery (e.g. a cylinder-shape battery, a box-shape battery, etc.). Hereinafter, the structure of the present invention will be explained by making reference to the accompanied drawings.

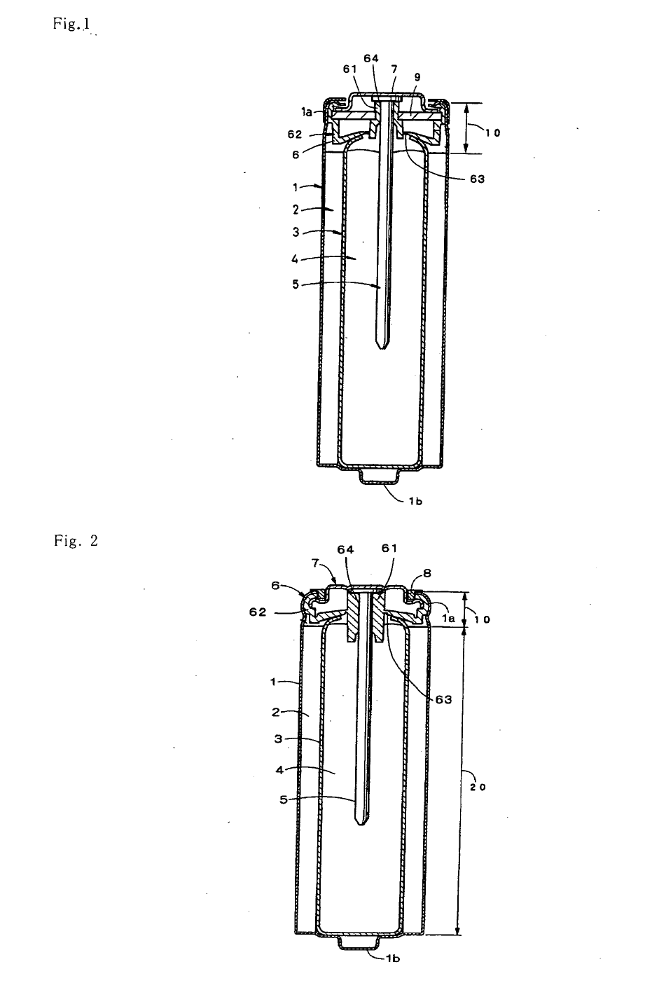

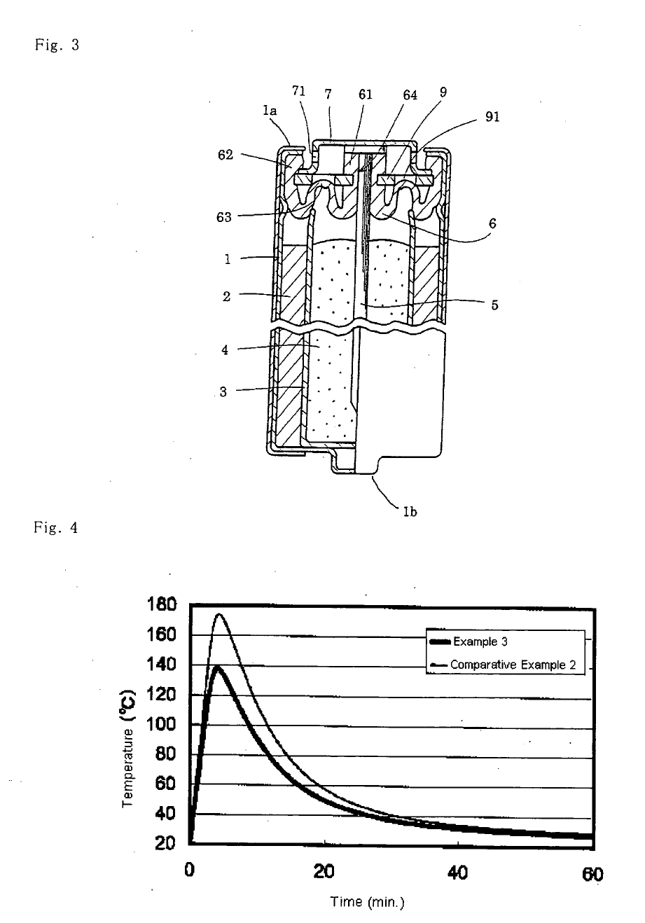

FIG. 1 shows the cross sectional view of one example of the alkaline battery according to the present invention. In the alkaline battery illustrated in FIG. 1, a positive electrode 2 (the molded body of the positive electrode mixture) in the form of a bobbin is placed in an outer can 1 made of a metal (e.g. nickel-plated iron, stainless steel, etc.). Within the positive electrode 2, a cup-form separator 3 is placed and an alkaline electrolytic solution (not shown) is poured inside the separator 3. Further, a negative electrode 4 containing zinc base particles (a gel-form negative electrode mixture) is filled inside the separator 3. A part 1b of the outer can 1 functions as a positive electrode terminal. The open end 1a of the outer can 1 is provided with a negative electrode-terminal plate 7 made of a metal (e.g. nickel-plated iron, stainless steel, etc.), and it is inwardly bent along the periphery 62 of a sealing member 6 made of a resin. To the negative electrode-terminal plate 7, a negative electrode collector rod 5 made of a metal (e.g. tin-plated brass, etc.) is welded at its head, and the negative electrode collector rod 5 is inserted into the negative electrode 4 via a through-hole 64 provided at the center part 61 of the sealing member 6. A metal washer 9 (a disc-form metal plate) is provided as a support means for preventing the deformation of the negative electrode plate 7 during sealing the opening of the can and for supporting the sealing member 6 from the inside. In addition, the resin sealing member 6 has a thin-walled part 63 for preventing explosion of the battery. When a gas is generated in the battery due to short-circuiting, the thin-walled part 63 of the sealing member 6 is preferentially broken, and the gas moves towards the side of the metal washer 9 through a hole formed. The metal washer 9 and the negative electrode-terminal plate 7 have respective gas-vent holes (not shown), and the gas generated in the battery is exhausted through the gas-vent holes. The thin-walled part 63 is well torn and thus the breakage of the battery is highly prevented, since the rise of the temperature caused by short-circuiting is suppressed in the battery of the present invention, and the softening of the sealing member 6 is prevented.

Since the alkaline battery of the present invention has the structure explained above, the surface temperature of the battery at the time of short-circuiting can be suppressed to 170° C. or lower. It may be contemplated from the structure of the alkaline battery that the temperature of the sealing member 6 at the time of short-circuiting may substantially the same as the surface temperature of the battery. Accordingly, the sealing member 6 is preferably made of a resin having a softening point higher than 170° C., for example, Nylon 66.

FIG. 2 shows the cross sectional view of another example of the alkaline battery of the present invention. In FIG. 2, elements having the same functions as those in FIG. 1 are denoted by the same reference numerals, and are not explained to avoid repetition. In FIG. 2, numeral 8 stands for an insulating plate to insulate the outer can from the negative electrode plate, and numeral 20 stands for a body part housing a power generating unit.

In the battery of FIG. 1, the volume occupied by the sealing part 10 becomes large since the metal washer 9 is used. In contrast, the battery of FIG. 2 does not use any washer but utilizes the negative electrode-terminal plate 7 as a supporting means which support the sealing member 6 from the inside. Thereby, the volume of the body part 20, which houses the power generating unit, is increased while the volume of the sealing part 10 is decreased. Accordingly, the filling amounts of the mixtures of the positive electrode 2 and the negative electrode 4 can be larger than those in the battery of FIG. 1. The battery of FIG. 2 may have a problem such that the amount of heat generated at the time of short-circuiting increases with the increase of a capacity. However, when the battery has the structure of the present invention, the abnormal heat-generation can be suppressed. Therefore, even when the battery has the structure of FIG. 2, the breakage of the battery at the time of short-circuiting can effectively be prevented, and thus the battery has high practical utility.

### EXAMPLE

The present invention will be illustrated by the following examples, which do not limit the scope of the present invention in any way.

### Example 1

Manganese dioxide containing 1.6% by weight of water, graphite, polytetrafluoroethylene powder and an alkaline electrolytic solution for positive electrode mixture preparation (an aqueous solution comprising 56% by weight of potassium hydroxide with 2.9% by weight of zinc oxide) were mixed in a weight ratio of 87.6:6.7:0.2:5.5 at 50° C. to prepare a positive electrode mixture. In this mixture, 7.6 parts by weight of graphite was used based on 100 parts by weight of manganese dioxide. The concentration of potassium hydroxide in the electrolytic solution contained in the positive electrode mixture was 44.6% by weight with taking the water content of manganese dioxide into account.

Next, a zinc alloy particles containing indium, bismuth and aluminum in amounts of 0.05% by weight, 0.05% by weight and 0.005% by weight respectively, polysodium acrylate, polyacrylic acid and an alkaline electrolytic solution for negative electrode mixture (an aqueous solution comprising 33.5% by weight of potassium hydroxide with 2.2% by weight of zinc oxide) were mixed in a weight ratio of 39:0.2:0.2:18 to prepare a gel-type negative electrode mixture. The zinc alloy particles had an average particle size of 109 μm, all the particles of which passes through sieve openings of 80 mesh and 20% by weight of which passes through sieve openings of 200 mesh, and their bulk density was 2.63 g/cm³.

As the outer body of a battery, an outer can 1 for a size AA alkaline dry battery made of a killed steel plate, the surface of which is plated with matt Ni plating, was used. This can had a thickness of 0.25 mm in a sealing part 10 and a thickness of 0.16 mm in a barrel part 20. Furthermore, the thickness of the can at the positive electrode terminal part was slightly larger than that of the barrel part 20 to prevent the indentation of the positive electrode terminal 1b when the battery is dropped. Using this outer can, an alkaline battery was produced as follows.

About 11 g of the positive electrode mixture was charged in the outer can 1 and press-molded into a bobbin shape (hollow cylinder shape) to make three molded bodies of the positive electrode mixture, each having an inner diameter of 9.1 mm, an outer diameter of 13.7 mm and a height of 13.9 mm (density: 3.21/cm³), which were piled. Then, a groove was formed at 3.5 mm from an open end of the outer can 1 in the vertical direction, and pitch was applied to the inside of the outer can 1 to the groove position in order to improve an adhesion of the outer can 1 and the sealing member 6.

Next, three plies of a nonwoven fabric consisting of acetalized polyvinyl alcohol fiber (Vinylon® of KURARAY Co., Ltd.) and cellulose fiber (Tencel® of LENZING) with a thickness of 100 μm and a weight of 30 g/m² were laminated and rolled into a cylinder, and its bottom part was folded and heat-sealed to make a cup-shaped separator 3 having the bottom end closed. This separator 3 was placed in the inside of the positive electrode 1 inserted into the outer can, and injected with 1.35 g of an alkaline electrolytic solution (an aqueous solution comprising 33.5% by weight of potassium hydroxide with 2.2% by weight of zinc oxide) inside the separator. Then, 5.74 g of the negative electrode mixture was charged in the inside of the separator 3 to form a negative electrode 4. At this time, the total amount of water in the battery system was 0.261 g per gram of the positive electrode active material.

After filling the above components of the power generating unit, a negative electrode collector rod 5 was inserted in the center of the negative electrode 4. The negative electrode collector rod 5 consisted of a brass rod the surface of which was plated with tin, and was combined with a Nylon 66 sealing member 6. Then, the collector rod 5 was clamped from the outside of the open end 1a of the outer can 1 by a spinning method to produce an AA alkaline battery as shown in FIG. 2. Here, the negative electrode collector rod 5 used was beforehand attached by welding on a negative electrode-terminal plate 7, which was made of nickel-plated steel having a thickness of 0.4 mm formed by punching and press working. In addition, an insulating plate 8 was attached for prevention of short-circuit between the open end of the outer can 1 and the negative electrode-terminal plate 7. As described above, the alkaline batteries of Example 1 according to the present invention were produced.

### Example 2

An alkaline battery of this Example was produced in the same manner as in Example 1 except that zinc alloy particles having an average particle size of 102 μm, all the particles of which passes through sieve openings of 80 mesh and 30% by weight of which passes through sieve openings of 200 mesh, were used in the negative electrode.

### Example 3

An alkaline battery of this Example was produced in the same manner as in Example 1 except that zinc alloy particles having an average particle size of 95 μm, all the particles of which passes through sieve openings of 80 mesh and 40% by weight of which passes through sieve openings of 200 mesh, were used in the negative electrode.

### Example 4

An alkaline battery of this Example was produced in the same manner as in Example 1 except that zinc alloy particles having an average particle size of 89 μm, all the particles of which passes through sieve openings of 80 mesh and 50% by weight of which passes through sieve openings of 200 mesh, were used in the negative electrode.

### Example 5

An alkaline battery of this Example was produced in the same manner as in Example 1 except that zinc alloy particles having an average particle size of 82 μm, all the particles of which passes through sieve openings of 80 mesh and 60% by weight of which passes through sieve openings of 200 mesh, were used in the negative electrode.

### Example 6

An alkaline battery of this Example was produced in the same manner as in Example 1 except that zinc alloy particles having an average particle size of 75 μm, all the particles of which passes through sieve openings of 80 mesh and 70% by weight of which passes through sieve openings of 200 mesh, were used in the negative electrode.

### Example 7

An alkaline battery of this Example was produced in the same manner as in Example 1 except that zinc alloy particles having an average particle size of 69 μm, all the particles of which passes through sieve openings of 80 mesh and 80% by weight of which passes through sieve openings of 200 mesh, were used in the negative electrode.

### Comparative Example 1

An alkaline battery of this Comparative Example was produced in the same manner as in Example 1 except that zinc alloy particles having an average particle size of 116 μm, all the particles of which passes through sieve openings of 80 mesh and 10% by weight of which passes through sieve openings of 200 mesh, were used in the negative electrode.

### Comparative Example 2

An alkaline battery of this Comparative Example was produced in the same manner as in Example 1 except that zinc alloy particles having an average particle size of 63 μm, all the particles of which passes through sieve openings of 80 mesh and 90% by weight of which passes through sieve openings of 200 mesh, were used in the negative electrode.

### Comparative Example 3

An alkaline battery of this Comparative Example was produced in the same manner as in Example 1 except that zinc alloy particles having an average particle size of 57 μm, all the particles of which passes through sieve openings of 80 mesh and 100% by weight of which passes through sieve openings of 200 mesh, were used in the negative electrode.

### Comparative Example 4

An alkaline battery of this Comparative Example was produced in the same manner as in Example 1 except that zinc alloy particles having an average particle size of 127 μm, all the particles of which passes through sieve openings of 35 mesh, 20% by weight of which passes through sieve openings of 80 mesh and 20% by weight of which passes through sieve openings of 200 mesh, were used in the negative electrode.

### Comparative Example 5

An alkaline battery of this Comparative Example was produced in the same manner as in Example 1 except that zinc alloy particles having an average particle size of 111 μm, all the particles of which passes through sieve openings of 35 mesh, 30% by weight of which passes through sieve openings of 80 mesh and 30% by weight of which passes through sieve openings of 200 mesh, were used in the negative electrode.

### Comparative Example 6

An alkaline battery of this Comparative Example was produced in the same manner as in Example 1 except that zinc alloy particles having an average particle size of 90 μm, all the particles of which passes through sieve openings of 35 mesh, 50% by weight of which passes through sieve openings of 80 mesh and 50% by weight of which passes through sieve openings of 200 mesh, were used in the negative electrode.

### Comparative Example 7

An alkaline battery of this Comparative Example was produced in the same manner as in Example 1 except that zinc alloy particles having an average particle size of 77 μm, all the particles of which passes through sieve openings of 35 mesh, 70% by weight of which passes through sieve openings of 80 mesh and 70% by weight of which passes through sieve openings of 200 mesh, were used in the negative electrode.

### Comparative Example 8

An alkaline battery of this Comparative Example was produced in the same manner as in Example 1 except that zinc alloy particles having an average particle size of 71 μm, all the particles of which passes through sieve openings of 35 mesh, 80% by weight of which passes through sieve openings of 80 mesh and 80% by weight of which passes through sieve openings of 200 mesh, were used in the negative electrode.

With the alkaline batteries produced in Examples and Comparative Examples, the load characteristics and the safety were evaluated by the methods described below.

Evaluation of Load Characteristics

In this test, nine alkaline batteries produced in each of Examples and Comparative Examples were repeatedly discharged at a discharge current of 2.0 A for a period of 2 seconds with stopping discharge for 58 seconds between the discharge periods. The end of the 2 second discharge per minute to 1.0 V was counted “one time”, and the average number of the times where the 2 second discharge to 1.0 V (pulse discharge) was possible was calculated to evaluate the load characteristics. The larger number of the pulse discharges means the better load characteristics of the battery.

Evaluation of Safety of Battery

In this test, nine alkaline batteries produced in each of Examples and Comparative Examples, which were different from those used in the above evaluation test of load characteristics, were used.

A thermocouple was attached to the middle portion of the side face of the outer can of each alkaline battery. Then, the surface temperature of the outer can (battery surface temperature) was measured at the time of short-circuiting, and the measured temperature values were averaged to evaluate the heating behavior at the time of short-circuiting and the breakage of the batteries. FIG. 4 shows the change of the surface temperature of the outer cans of the batteries produced in Example 3 and Comparative Example 2.

TABLE 1

| | | | | | | Safety evaluation | |
|---|---|---|---|---|---|---|---|
| | | | | Average | | Maximum | No. of |
| | Amount of zinc alloy | | | particle | | surface | broken |
| | particles passing: | | | size of | | temperature | batteries/ |
| | 35 | 80 | 200 | zinc alloy | No. of | of | No. of |
| Example | mesh | mesh | mesh | particles | pulse | outer can | batteries |
| No. | (wt. %) | (wt. %) | (wt. %) | (μm) | discharge | (° C.) | tested |
| 1 | 100 | 100 | 20 | 109 | 86 | 124 | 0/9 |
| 2 | 100 | 100 | 30 | 102 | 89 | 131 | 0/9 |
| 3 | 100 | 100 | 40 | 95 | 92 | 138 | 0/9 |
| 4 | 100 | 100 | 50 | 89 | 95 | 145 | 0/9 |
| 5 | 100 | 100 | 60 | 82 | 93 | 152 | 0/9 |
| 6 | 100 | 100 | 70 | 75 | 92 | 160 | 0/9 |
| 7 | 100 | 100 | 80 | 69 | 89 | 167 | 0/9 |

TABLE 2

| | | | | | | Safety evaluation | |
|---|---|---|---|---|---|---|---|
| | Percentage of | | | Average | | Maximum | No. of |
| | zinc alloy | | | particle | | surface | broken |
| | particles passing: | | | size of | | temperature | batteries/ |
| Comparative | 35 | 80 | 200 | zinc alloy | No. of | of | No. of |
| Example | mesh | mesh | mesh | particles | pulse | outer can | batteries |
| No. | (wt. %) | (wt. %) | (wt. %) | (μm) | discharge | (° C.) | tested |
| 1 | 100 | 100 | 10 | 116 | 83 | 117 | 0/9 |
| 2 | 100 | 100 | 90 | 63 | 87 | 174 | 9/9 |
| 3 | 100 | 100 | 100 | 57 | 85 | 177 | 9/9 |
| 4 | 100 | 20 | 20 | 127 | 78 | 126 | 0/9 |
| 5 | 100 | 30 | 30 | 111 | 80 | 133 | 0/9 |
| 6 | 100 | 50 | 50 | 90 | 83 | 146 | 0/9 |
| 7 | 100 | 70 | 70 | 77 | 82 | 159 | 0/9 |
| 8 | 100 | 80 | 80 | 71 | 81 | 165 | 0/9 |

As can be seen from the results in Tables 1 and 2, the alkaline batteries of Examples 1-7 according to the present invention had excellent load capacity. In addition, with those batteries, the heat-generation at the time of short-circuiting was suppressed, and thus the maximum surface temperature of the outer can was 170° C. or less so that the sealing member was not softened and the explosion of the batteries was prevented. In those batteries, since the surface temperature of the outer can was lower than the softening point of the sealing member, the batteries have no problem from the viewpoint of safety in the mass production. In particular, the alkaline batteries of Examples 2, 3 and 4 had excellent balance between the load characteristics and the suppression of the heat-generation at the time of short-circuiting.

With the alkaline battery of Comparative Example 1 in which the amount of the fine zinc alloy particles was small, the surface temperature of the outer can was low but had the inferior load characteristics to the batteries of the Examples. With the alkaline batteries of Comparative Examples 2 and 3 in which the amount of the fine zinc alloy particles was too large, the pulse discharge number could be increased, but the surface temperature of the outer can rose to much higher temperature than that in the batteries of the Examples and became higher than the softening point of the sealing member. Accordingly, all of the nine batteries were broken. Thus, the safety of the batteries of those Comparative Examples were low.

The alkaline batteries of Comparative Examples 4 to 8 which used the zinc alloy particles containing particles which do not pass through sieve openings of 80 mesh had the inferior pulse discharge number to the batteries of the Examples.

What is claimed is:

1. An alkaline battery comprising a positive electrode, a negative electrode containing zinc or zinc alloy particles, an outer body, and a resin sealing member having a thin-walled part for preventing explosion, wherein all zinc or zinc alloy particles in the negative electrode pass through sieve openings of 80 mesh and 20 to 80% by weight of the zinc or zinc alloy particles pass through sieve openings of 200 mesh sieve.

2. The alkaline battery according to claim 1, wherein 50% by weight or less of said zinc or zinc alloy particles pass through sieve openings of 200 mesh sieve.

3. The alkaline battery according to claim 1, wherein at least 30% by weight of said zinc or zinc alloy particles pass through sieve openings of 200 mesh sieve.

4. The alkaline battery according to claim 2, wherein at least 30% by weight of said zinc or zinc alloy particles pass through sieve openings of 200 mesh sieve.

5. The alkaline battery according to claim 1, wherein said sealing member is made of Nylon 66 and a surface temperature of the battery is 170° C. or less at the time of short-circuiting.
